(19) United States
(12) Patent Application Publication
(10) Pub. No.: US 2013/0207404 A1
(43) Pub. Date: Aug. 15, 2013

(54) SECURITY LOCK

(71) Applicants: Eddie Rundgren, Roverud (NO); Kai Pedersen, Roverud (NO)

(72) Inventors: Eddie Rundgren, Roverud (NO); Kai Pedersen, Roverud (NO)

(73) Assignee: NORWAYLOCKS AS, Roverud (NO)

(21) Appl. No.: 13/879,548

(22) PCT Filed: Oct. 11, 2011
(86) PCT No.: PCT/EP2011/067711

§ 371 Date: Apr. 15, 2013

(30) Foreign Application Priority Data
Oct. 14, 2010 (NO) 20101433

(51) Int. Cl. E05C 1/08; E05B 17/00

(52) U.S. Cl. CPC E05C 1/08; E05B 17/0004
USPC 292/156; 29/428

(57) ABSTRACT

A security lock secures a locking assembly to a stopping member. A bolt extends in a longitudinal direction from a housing into the stopping member. When the bolt is extended, a set of first latching members extends laterally from the bolt and abuts a front face of the housing. A force applied to the end of the bolt is transferred through first latching members to the housing rather than to the mechanism within the locking assembly. A set of second latching members extend laterally into engagement with an interior surface of the stopping member to transfer part of the longitudinal force to the stopping member. The latching members are retracted into the bolt when the bolt is retracted into the housing.

### BACKGROUND

1. Field of the Invention

The present invention concerns a security lock for securing a locking assembly to a stopping member, and a method for its use.

2. Prior and Related Art

A locking assembly can be disposed within a door and a stopping member within a door frame or vice versa. When a bolt bridges the gap between the two, the door is latched or secured to the frame. A similar arrangement can be used to lock a drawer, etc. In general, the term “lock” as used herein is intended to mean a mechanical latching mechanism where a bolt can bridge a gap between a locking assembly and a stopping member, thereby preventing lateral motion between them. For the sake of simplicity, a door lock where the locking assembly is disposed in a door and the stopping member is disposed within a doorframe is used in the following examples. However, other applications where a lateral motion of a locking assembly with respect to a stopping member is prevented by a bolt extending in a longitudinal direction are anticipated.

In a simple form, the bolt is pressed into the stopping member by a spring, and the bolt is retracted into the locking assembly by a door knob or a handle This mechanism is frequently combined with a separate key operated lock, where the door knob or handle is replaced with a locking cylinder operable by a removable key fitting in the particular locking cylinder. Any locking cylinder can be used together with the present invention. However, a brief discussion of locking cylinders in general is believed to improve understanding the present invention.

The main principle of a key operable locking cylinder is that the cylinder can only be rotated with respect to an outer housing if a key fitting the cylinder is presented. The locking cylinder is coupled to the bolt through a mechanism, such that turning the locking cylinder in one direction causes the bolt to extend from the locking assembly and engage a stopping plate or some other reinforcing stopping member, and turning the locking cylinder in the other direction causes the bolt to disengage from the stopping member to permit opening of the door. In a first example, a mechanical key displaces pins, plates, or rotating discs into positions where the elements within the locking cylinder can be rotated with respect to each other. A second example is a key that is scanned electronically, optically or magnetic, and a lock where the bolt is displaced by an electric motor if and only if the scan fits a predetermined pattern. There are also known mechanisms where a doorknob is used to rotate the locking cylinder, such that the door knob cannot be rotated before a key permits rotation.

In a typical entrance door restricting access to premises such as an apartment, a house, an office, etc., the door, the frame and the hinges are relatively simple mechanisms. This means they are relatively inexpensive to manufacture, and can be made robust without excessive cost. In comparison, the lock is a more complex mechanism with small parts and close tolerances. To avoid excessive cost, the lock tends to be made from relatively inexpensive, and thus not particularly strong, materials. The combination of small parts and relatively inexpensive materials in the mechanism makes the lock a preferred point of attack for someone wanting to break into the premises. One method for breaking in is so-called jimmying, where a crowbar or similar instrument is inserted in the extension of the bolt. When leverage is applied to the crowbar, the bolt is forced against the mechanism in the lock, causing one or more of the relatively small and inexpensive parts to break. It is noted that mounting a protective plate fixed to the door frame to prevent insertion of a crowbar is not an option in countries where an entrance door is required to swing outwards in case of fire or danger. Similar protective plates are sometimes mounted on steel doors, but rarely on a typical entrance door leading to an apartment or a home.

Another method to gain unauthorised access is to drill along the rotation axis of the locking cylinder in order to break the rotation locking elements or the retainer keeping them in place. Once the pins or other elements keeping the cylinder from rotating are broken, the locking cylinder can be rotated to unlock the door.

In some designs, the bolt or latching member is a hook rotating into or out of engagement with the stopping member. However, such hooks can be forced open by jimmying in the direction of rotation rather than in the longitudinal direction of the bolt. Further, a hook makes no difference if the locking cylinder is drilled.

In the examples above, the burglar gains access to the premises once the bolt is forced or retracted into the locking assembly.

A main objective of the present invention is to solve at least one of the above problems, while keeping the benefits of prior art.

### SUMMARY OF THE INVENTION

The main objective is achieved by providing a security lock for securing a locking assembly to a stopping member, where the locking assembly comprises a housing containing a bolt where the bolt is movable between a retracted position where the bolt is disposed entirely within the housing, and an extended position where part of the bolt extends in a longitudinal direction from a front face of the housing into the stopping member. The security lock is distinguished by a set of first latching members, wherein each first latching member is movable in a lateral direction parallel to the front face between a position entirely within the bolt when the bolt is in the retracted position, and wherein part of the first latching member extends from the bolt and abuts the front face when the bolt is in the extended position.

In another aspect, the invention concerns a method for securing a locking assembly of the kind above to a stopping member, the method comprising the step of causing the set of first latching members to extend laterally from the bolt into engagement with the front face, whereby a load imposed longitudinally on the bolt in the direction from the stopping member toward the housing is transferred through the set of first latching members to the housing.

In other words, a load or force applied to the extended bolt will transfer through the first latching members, which abuts the front face, to the housing, rather than to a mechanism comprising small parts within the housing. As the latching members and the housing can be made robust in a relatively easy manner, the lock's resistance to jimmying is improved significantly without a corresponding increase in the cost of manufacture.

In a preferred embodiment, second latching members engage the stopping member in a similar manner. Further, the housing and stopping member may have cylindrical outer surfaces, such that mounting the security lock simply involves drilling coaxial bores in the door and frame respectively, and inserting the locking assembly and stopping member into their respective bores.

Further features and benefits of the present invention will become apparent from the attached claims and the following detailed description.

### BRIEF DESCRIPTION OF THE DRAWINGS

The invention will be better understood from the following detailed description with reference to the accompanying drawings, in which:

FIG. 1 is a schematic top view of a security lock according to the invention;

FIG. 2a is a front view of a cylindrical locking assembly;

FIG. 2b is a front view of a rectangular locking assembly;

FIG. 3 is a top view of a guide for use in the locking assembly;

FIG. 4a is a side view of the guide in FIG. 3;

FIG. 4b is a diagram illustrating a transfer of forces in FIG. 4a; and

FIG. 5 is another side view of the guide in FIG. 3.

### DETAILED DESCRIPTION OF A PREFERRED EMBODIMENT

The drawings are intended to illustrate the principles of the invention. They are not to scale, and several details are omitted for clarity.

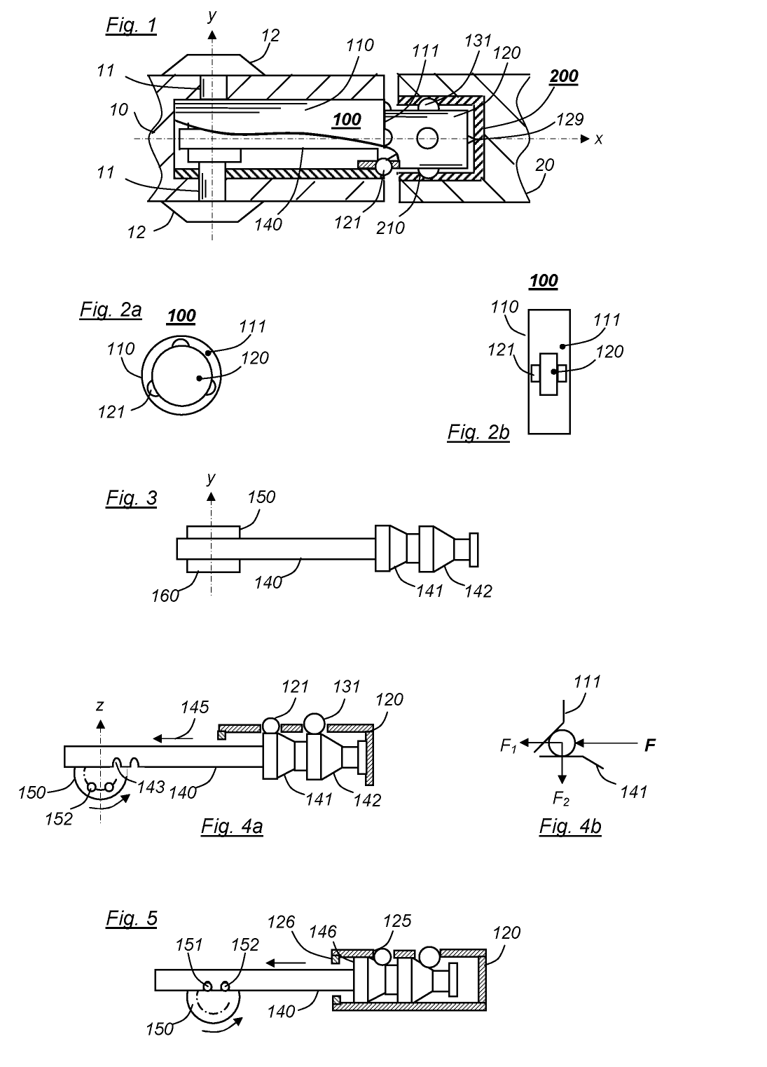

FIG. 1 is a schematic, partially cut through, top view of a security lock according to the invention. A locking assembly 100 is mounted within a door 10. Rotating a locking cylinder 11 about the y-axis causes a bolt 120 to extend into a stopping member 200 to lock the door, or retract the bolt 120 from the stopping member 200 to open the door. A typical locking cylinder 11 is rotated by a key inserted into it, and will not rotate unless a fitting key is inserted.

FIG. 1 shows two locking cylinders 11 operating independently of each other. Each locking cylinder 11 is attached to the door 10 and locking assembly 100 by covers 12 and screws (not shown) through the covers 12 and door 10. The positions of the screws, and hence of holes or recesses in the locking assembly to provide passages for the screws, is standardised. This makes it possible to combine locking assemblies and locking cylinders, even if they come from different manufacturers. If a key is lost, this standardisation also makes it possible to replace a locking cylinder or two without having to replace the entire locking assembly. While not shown in the drawings, it is understood that the locking assemblies of the present invention are provided with holes and/or recesses in the standardised locations to permit passage of the fastening screws.

The stopping member 200 is mounted within a doorframe 20 to receive the bolt 120 from the locking assembly 100 mounted in the door 10. As discussed above, the opposite arrangement is also possible, and the embodiment with two mechanical key operated locking cylinders is an example only. Thus, elements 10-20 illustrate an example of how the locking assembly 100 and stopping member 200 can be used, and have been assigned reference numerals below 100 to indicate that they are not part of the invention.

The bolt 120 is movable relative to the housing 110 in a longitudinal direction indicated by the x-axis in FIG. 1, between a retracted position where the bolt 120 is disposed entirely within the housing 110, and an extended position where part of the bolt 120 extends from a front face 111 of the housing 110 into the stopping member 200. FIG. 1 shows the bolt 120 in its extended position.

When the bolt 120 is in its extended position and has entered the stopping member 200, a set of first latching members 121 extend from the bolt 120 in a direction parallel to the front face 111 of the housing 110. The directions parallel to the front face 111 are perpendicular to the longitudinal direction x, and are called ‘lateral directions’ in the following. In other words, a lateral direction is any direction perpendicular to the longitudinal direction x, i.e. any direction in a plane spanned by the y and z axes in FIGS. 3 and 4.

The extended latching members 121 abuts the front face 110, and serves to transfer any force applied to the end of the bolt in the direction toward the housing, to the housing 110 rather than to small parts in the locking cylinder 11 and/or within the locking assembly 100. The transfer of forces is further discussed in conjunction with FIG. 4b below.

FIG. 1 also shows a set of second latching members 131 extending laterally from the bolt 120 into recesses or bores in the stopping member 200. The secondary latching members 131 serves the same purpose as the hooked bolt briefly discussed in the introduction. However, in contrast to the hooked bolt, there is no rotational direction available for jimmying in the embodiment of FIG. 1, because the second latching members 131 are distributed along the circumference of the bolt 120. In order to transfer forces from the bolt 120 to the stopping member 200, it is necessary and sufficient that the second latching members abut an internal, laterally extending face 210 within the stopping member 200. Lateral bores or recesses for receiving latching members 121, 131 are anticipated, but not explicitly specified in the claims.

FIGS. 2a and 2b are front views of two embodiments of the locking assembly 100, i.e. as the embodiments would appear when viewed along the x-axis from right to left in FIG. 1. Both embodiments comprise latching members 121 extending laterally from the bolt 120 into engagement with the front face 111 of the housing 110.

A cylindrical locking assembly 100, for example as shown in FIGS. 1 and 2a, is useful for installation in an already mounted door, for example as an extra security lock in addition to an existing lock. Installation of the cylindrical embodiment requires drilling only, for example, drilling a 30 mm bore in a 40 mm wide face of the door, rather than milling or manually carving out a recess for a rectangular assembly 110 such as the one in FIG. 2b. Further, the bolt 120 may be provided with a small marking tip 129 to mark the centre of a corresponding bore for a cylindrical stopping member 200. A cylindrical housing 110 also deflects a drill not directed exactly radial to its axis of rotation, and thus makes drilling more difficult for a potential burglar. This effect is easily and inexpensively enhanced by manufacturing the housing 110 from a tensile material that is easily hardened, for example from a steel quality that is easily machined and easily surface hardened. In an application where a locking cylinder 11 is provided on the inner side of a door or frame only, for example a locking cylinder 11 rotated by an electric motor, a cylindrical housing 110 made from hardened steel may provide extra protection against attempts to drill through the housing 110 and/or locking cylinder 11 in order to gain access to the premises.

A rectangular embodiment, such as the one illustrated in FIG. 2b, fits into a previously milled recess in a door, and is thus useful for replacing an existing locking assembly, or for mounting in a new door having a prefabricated rectangular recess.

In applications where a locking cylinder is accessible from the outside of the door, this locking cylinder should provide reasonable protection against drilling, for example by providing a face of hardened steel and using other protective means well known in the art.

FIG. 1 shows the latching members 121 as balls extending at right angles to each other, and may represent an embodiment with a set of four latching members 121. FIG. 2a shows a cylindrical embodiment with a set of three latching members 121, and FIG. 2b shows a rectangular embodiment of the housing 110 with two latching members 121, which may be cylinders or lugs. It should be understood that several shapes of the housing 110, one or more first latching members 121, and zero or more second latching members 131 are anticipated. Further, the first 121 and second 131 latching member may have the shape of a ball, a cylinder, a lug, a pin, or any other shape provided the latching member 121, 131 can be retracted into the bolt 120 when the bolt is retracted into the housing 120, and provided the latching member can transfer a force from the bolt to the housing 110 and stopping member 200 respectively. Steel balls of a kind used in ball bearings are readily available, inexpensive and well suited for use as latching members 121, 131 in the present invention.

FIG. 3 shows a guide 140 and two activating discs 150, 160 partly visible in FIG. 1, and the y-axis in FIG. 3 corresponds to the y-axis in FIG. 1. The locking cylinders 11 on either side of the locking assembly 100 in FIG. 1 would engage the activation discs 150 and 160 respectively, each locking cylinder 11 being rotation locked to one activation disc 150 or 160. The discs 150 and 160 can be rotated independent of each other, and each disc 150 or 160 can move the guide 140 longitudinally, i.e. from the right to left or vice versa in FIGS. 1 and 3. This motion retracts or extends the bolt 120 and latching members 121, 131 as further described in the following.

The guide 140 comprises at least one inclined face 141, 142. The inclination is in the longitudinal direction, and serves to move the latching members 121, 131 laterally when the guide 140 is moved longitudinally. A cylindrical part of the guide 140 comprising frustoconical faces 141, 142 may be disposed within a cylindrical bore in the bolt 120 regardless of the outer shape of the bolt 120, for example, the circular shape in FIG. 2a and the rectangular shape in FIG. 2b. It is noted that plane surfaces inclined in the longitudinal direction will have the same effect of moving the latching members 121, 131 laterally when the guide 140 is moved longitudinally. The only requirement for the inclined faces 141, 142 to move the latching members 121, 131 laterally, is that each inclined face is in sliding engagement with a latching member 121, 131, and that the bolt 120 comprises at least one retainer 125 (FIG. 5) keeping the latching member at or near the inclined face 141, 142 when the guide 140 is moved longitudinally relative to the bolt 120. Although not explicitly shown in FIGS. 4 and 5, a retainer preventing the latching members 121, 131 from falling out of or escaping from the bolt is required. The term ‘keeping the latching member at or near the inclined face 141, 142’ in the claims is intended to include a retainer 125 keeping the latching members in position laterally as well as longitudinally.

It should be understood that other methods for moving the latching members 121, 131 laterally, for example biasing the latching members laterally by a spring, can be used instead of or in addition to the guide 140 with inclined faces.

FIG. 4a shows the guide 140 of FIG. 3 viewed from the side, i.e. in the direction indicated by the y-axis in FIG. 3. In other words, the z-axis in FIG. 4 points upwards, corresponding to the direction out of the paper plane in FIG. 1. The activation disc 150 shown in FIG. 4 has two teeth 151 (FIGS. 5) and 152, protruding in the direction out of the paper plane in FIG. 4. In FIG. 4, the teeth 151, 152 are disengaged from a set of corresponding recesses 143. Further, the guide 140 is in a position where the bolt 120 is extended longitudinally, and the latching members 121, 131 are extended laterally from the bolt 120. The activation disc 150 will be in the exact same position when the bolt 120 and latching members 121, 131 are fully retracted. Further, the teeth 151, 152 are configured to operate independently of corresponding teeth on the activation disc 160 shown in FIGS. 1 and 3. This can easily be achieved by teeth 151, 152 protruding less than halfway through the guide 140, i.e. downwards along the y-axis in FIG. 3, and provide similar teeth on disc 160 that extend less than half the thickness of guide 140 in the upward direction on FIG. 3. While the teeth 151, 152 are shown as pins protruding at right angles from a face of the activation disc 150, other arrangements known to one skilled in the art, such as a rack and pinion arrangement, are anticipated.

The activation discs 150 and 160 work in a similar manner, and hence only disc 150 is described in the following. Referring now to FIGS. 4a and 5, when disc 150 is rotated in the direction indicated by an arrow, i.e. counter-clockwise in FIGS. 4a and 5, the teeth 151, 152 will move from the disengagement in FIG. 4a into engagement with corresponding recesses 143 as shown in FIG. 5, and pull the guide to the left on FIGS. 1, 3, 4 and 5. Continued rotation from the position shown in FIG. 5 pulls the guide 140 to a position corresponding to the retracted position, where the latching members 121, 131 are disposed within the bolt 120 and the bolt 120 is disposed within the housing 110. In this retracted position, the activation disc 150 is rotated 360°, i.e. to the position shown in FIG. 4a, while the guide 140 would be disposed to the left compared to its position in FIG. 4a. The bolt 120 and latching members 121, 131 can be extended once more by rotating either activation disc 150 or 160 360° in the opposite direction.

Returning to FIG. 4a, latching members 121, 131 are shown in their extended position where they protrude from the bolt 120. It is understood that only part of the cross section of bolt 120 is shown. The guide 140 abuts an interior face of the bolt 120 to illustrate that the guide 140 is used to push the bolt 120 from its retracted to its extended position. When the guide 140 is moved to the left in FIGS. 4a and 5, an external face on the guide engages an internal face on the bolt 120 in a similar manner, such that the guide 140 pulls the bolt from its extended to its retracted position. The internal face of bolt 120 is represented by a locking ring 126 (FIG. 5).

The guide 140 is also movable relative to the bolt 120, such that the latching members 121, 131 can be moved laterally when the guide is moved longitudinally within the bolt 120.

In FIG. 4a, the latching members 121 and 131 engage a surface that is parallel to the longitudinal axis, rather than engaging an inclined face. This is to prevent transfer of longitudinal forces through the guide. The principle is illustrated in FIG. 4b, where a longitudinal force F is applied to a ball. The ball abuts an inclined surface of the front face 111, such that the force F becomes decomposed in a longitudinal component F₁, and a lateral component F₂. The longitudinal component F₁ is transferred to the front face 111, and hence to the housing 110 (not shown in FIG. 4b). The lateral component F₂ is directed laterally into the guide 140 through the surface that is parallel to the longitudinal axis, and is taken up by the guide. If the force F₂ was applied to the inclined face 141, it could, at least in theory, provide a longitudinal force component through the guide. When a latching member engages a surface parallel to the longitudinal axis as shown in FIG. 4b, the lateral force F₂ will only cause a longitudinal force on the guide 140 due to friction. This friction force can easily be made very small compared to the force F₁ transferred to the housing 110.

FIG. 5 shows the guide 140 and bolt 120 in an intermediate position between the fully retracted and extended positions. In this position, the latching members 121, 131 are retained on the inclined or sloping faces 141, 142 respectively, by retainers 125.

Regardless of the particular embodiment of the security lock, rotating the locking cylinder 11 and/or activation disc 150, 160 in a first direction will cause the bolt 120 to extend longitudinally from the housing 110 into a stopping member 200, and the set of first latching members 121 to extend laterally from the bolt 120 into engagement with the front face 111 of the housing 110. Thereby, a load or force F imposed longitudinally on the bolt in the direction from the stopping member 200 toward the housing 110 is transferred through the set of first latching members 121 to the housing 110.

The rotation in the first direction may also cause the set of second latching members 131 to extend laterally from the bolt 120 into engagement with a complementary face 210 within the stopping member 200, whereby the load or force F is partially transferred through the set of second latching members 131 to the stopping member 200.

Rotating the locking cylinder 11 and/or activation disc 150, 160 in a second direction opposite the first direction will cause the latching members 121, 131 to retract into the bolt 120, and the bolt 120 to retract into the housing 110.

In one embodiment, the housing 110 is cylindrical, and thus can be mounted in a bore with internal diameter equal to the outer diameter of the housing. Drilling a bore is easier than milling or manually carving a recess in a door or frame, especially when the door is already mounted. The bolt 120 can conveniently be provided with a small marking tip 129, which can be used to mark the centre for a corresponding bore for a cylindrical stopping member 200.

A hole can be drilled through, or partly trough, the door perpendicular to the first bore, such that a locking cylinder 11 can be inserted to engage the locking assembly 100 and be accessible from a side of the door.

The invention is fully defined by the following claims:

1. Security lock for securing a locking assembly to a stopping member, the locking assembly comprising a housing containing a bolt, where the bolt is movable between a retracted position where the bolt is disposed entirely within the housing, and an extended position where part of the bolt extends in a longitudinal direction from a front face of the housing into the stopping member, and comprising a set of first latching members, wherein each first latching member is movable in a lateral direction parallel to the front face between a position entirely within the bolt when the bolt is in the retracted position, and wherein part of the first latching member extends from the bolt and engages the front face when the bolt is in the extended position.

2. Security lock according to claim 1, further comprising a set of second latching members, wherein each second latching member is movable in the lateral direction between a position entirely within the bolt when the bolt is in the retracted position, and wherein part of the second latching member extends from the bolt and engages a face within the stopping member when the bolt is in the extended position.

3. Security lock according to claim 1, wherein a guide comprising at least one inclined face is disposed within the bolt, where each inclined face is in sliding engagement with a latching member, the bolt comprising at least one retainer keeping the latching member at or near the inclined face, the guide being movable between a retracted position where the latching member is retracted into the bolt and an extended position where the latching member engages the top of the inclined face and extends laterally from the bolt.

4. Security lock according to claim 1, wherein the first and/or second latching members are biased in the lateral direction.

5. Security lock according to claim 1, wherein the first and second latching members are selected from a group comprising a ball, a roller, a pin, and a lug.

6. Security lock according to claim 1, wherein the outer face of the housing, the bolt and/or the stopping member is/are substantially cylindrical.

7. Security lock according to claim 1, wherein the housing, the bolt, the latching members, and/or stopping member is/are manufactured from a tensile and hard material.

8. Security lock according to claim 1, wherein the outer end of the bolt is provided with a marking tip.

9. Security lock according to claim 1, wherein the housing comprises a first and second activation disc, each disk being rotatable ±360° about a common, laterally directed activation axis independent of the other disc, each disc comprising a set of teeth configured to engage and disengage a set of recesses along a guide during a complete rotation of the activation disc, whereby rotating either activation disc through 360° in one direction moves the guide longitudinally from a position corresponding to the first position where the bolt is in its retracted position to a position corresponding to the second position where the bolt is in its extended position, and rotating either activation disc through 360° in the opposite direction moves the guide longitudinally from a position corresponding to the second position where the bolt is in its extended position to a position corresponding to the first position where the bolt is in its retracted position.

10. Security lock according to claim 9, where at least one locking cylinder extends laterally through the housing into engagement with the activation disc(s).

11. Method for securing a locking assembly according to claim 1 to a stopping member, the method comprising the step of causing the set of first latching members to extend laterally from the bolt into engagement with the front face, whereby a load imposed longitudinally on the bolt in the direction from the stopping member toward the housing is transferred through the set of first latching members to the housing.

12. Method according to claim 11, further comprising the step of causing the set of second latching members to extend laterally from the bolt into engagement with a complementary face within the stopping member, whereby a load imposed longitudinally on the bolt in the direction from the stopping member toward the housing is partially transferred through the set of second latching members to the stopping member.

13. Method according to claim 11, wherein the outer face of the housing, the bolt and/or the stopping member is/are substantially cylindrical, said method further comprising the steps of:
drilling a first bore with diameter corresponding to the diameter of the cylinder corresponding to the housing in the longitudinal direction into a door or frame, and
inserting the cylindrical housing of into the first bore.

14. Method according to claim 11, wherein the outer end of the bold is provided with a marking tip, said method further comprising the steps of:
using the marking tip to mark a centre in the extension of the bolt,
drilling a second bore with a diameter corresponding to the diameter of the stopping member in the longitudinal direction, the centre of the second bore corresponding to the centre marked with the marking tip, and
inserting a cylindrical stopping member in the second bore.

15. Method according to claim 11, further comprising the step of drilling at least one lateral cylinder hole with a diameter corresponding to a locking cylinder, and the centre of the cylinder hole corresponding to the rotation axis of an activation disc.

16. Security lock according to claim 2, wherein a guide comprising at least one inclined face is disposed within the bolt, where each inclined face is in sliding engagement with a latching member, the bolt comprising at least one retainer keeping the latching member at or near the inclined face, the guide being movable between a retracted position where the latching member is retracted into the bolt and an extended position where the latching member engages the top of the inclined face and extends laterally from the bolt.

17. Security lock according to claim 2, wherein the first and/or second latching members are biased in the lateral direction.

18. Security lock according to claim 3, wherein the first and/or second latching members are biased in the lateral direction.

19. Security lock according to claim 2, wherein the first and second latching members are selected from a group comprising a ball, a roller, a pin, and a lug.

20. Security lock according to claim 3, wherein the first and second latching members are selected from a group comprising a ball, a roller, a pin, and a lug.
